(19) United States
(12) Patent Application Publication
(10) Pub. No.: US 2016/0155002 A1
(43) Pub. Date: Jun. 2, 2016

(54) HAZARD WARNING METHOD AND PORTABLE DEVICE UTILIZING THE SAME

(71) Applicants: Inventec (Pudong) Technology Corporation, Shanghai (CN); INVENTEC CORPORATION, Taipei (TW)

(72) Inventor: Hsiang-Yi Chang, Taipei (TW)

(21) Appl. No.: 14/692,089

(22) Filed: Apr. 21, 2015

(30) Foreign Application Priority Data
Nov. 27, 2014 (CN) 201410709658.X

(51) Int. Cl. G06K 9/00; G08B 21/02

(52) U.S. Cl. CPC G06K 9/00771; G08B 21/02; G06K 9/00805

(57) ABSTRACT

A hazard warning method for a portable device comprises the steps of: capturing an environmental image toward a first direction when receiving a control signal, and generating a warning signal when the environmental image comprises a dangerous object therein. The aforementioned portable device comprises an image capturing module, a storage module, and a determining module. The image capturing module is used for capturing the environmental image toward the first direction when receiving the control signal. The storage module is used for storing an object database. The determining module is used for determining whether the environmental image having a dangerous object defined in the object database, and generating the warning signal when the environmental image has the dangerous object.

### CROSS-REFERENCE TO RELATED APPLICATIONS

This non-provisional application claims priority under 35 U.S.C. §119(a) on Patent Application No(s). 201410709658.X filed in China on Nov. 27, 2014, the entire contents of which are hereby incorporated by reference.

### BACKGROUND OF THE INVENTION

1. Technical Field of the Invention

The present invention relates to a hazard warning method and a portable device utilizing the same, particularly to a hazard warning method and a portable device utilizing the same applying the image comparison technique.

2. Description of the Related Art

Currently the user usually needs to lower his head when using the portable device, so phubbers are becoming more and more common. However, when the user is staring at the monitor when walking, he may encounter the danger accidentally and get injured because of not notice the obstacles ahead, such as the coming car or the bumpiness. Therefore, a tool for the user to watch the road conditions is needed for notifying the user in advance to avoid any accident when possible obstacles occur ahead.

### SUMMARY OF THE INVENTION

A hazard warning method adapted for a portable device having an image capturing module includes using the image capturing module to capture a environmental image toward a first direction when receiving a control signal, determining whether the environmental image includes a dangerous object defined in an object database, and generating a warning message when the environmental image includes the dangerous object.

A portable device includes an image capturing module, a storage module, and a determining module. The image capturing module is for capturing an environmental image toward a first direction when receiving a control signal. The storage module is for storing an object database. The determining module is electrically connected with the image capturing module and the storage module and is for determining whether the environmental image includes a dangerous object, wherein the dangerous object is defined in the object database, and a warning message is generated when the environmental image is determined that the dangerous object is included.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1A is a diagram of the outward appearance of the portable device according to an embodiment of the present invention;

FIG. 1B is a functional block diagram corresponding to FIG. 1A;

FIG. 2 is a diagram of the environmental image according to an embodiment of the present invention;

FIG. 3A to 3C are diagrams of accelerations of the portable device according to an embodiment of the present invention;

FIG. 4 is a usage diagram of the portable device according to an embodiment of the present invention;

FIG. 5 is a flowchart of the hazard warning method applied by the portable device according to an embodiment of the present invention; and

FIG. 6 is a flowchart of the step 5700 according to an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

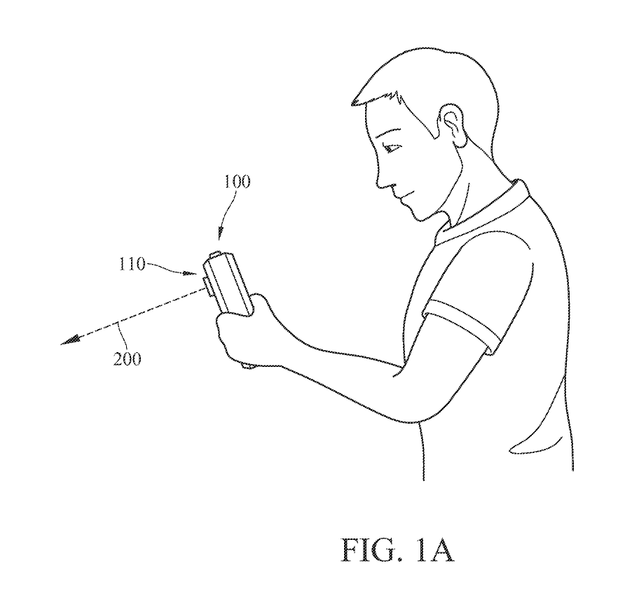

Please refer to FIG. 1A and FIG. 1B. FIG. 1A is a diagram of the outward appearance of the portable device according to an embodiment of the present invention. FIG. 1B is a functional block diagram corresponding to FIG. 1A. As shown in FIG. 1A, the portable device 100 illustrated in an embodiment of the present invention has an image capturing module 110. As shown in FIG. 1B, the aforementioned portable device 100 further has a storage module 120 and a determining module 130. The determining module 130 is electrically connected with the image capturing module 110 and the storage module 120. The image capturing module 110 is but not limited to a charge-coupled device (CCD), a complementary metal-oxide-semiconductor (CMOS) CCD, or other electronic component suitable for capturing images. The storage module 120 is but not limited to a flash memory, a disk, an electrically-erasable programmable read-only memory (EEPROM), or a non-volatile memory component.

Please refer back to FIG. 1A. The image capturing module 110 in the present embodiment captures an environmental image toward a first direction 200 when receiving the control signal. The environmental image is sent to the determining module 130. The determining module 130 includes an image analysis unit 131 and an image comparison unit 133. Practically the determining module 130 is but not limited to a central processing unit, a single chip processor, a programmable logic array (PLA), or other electronic component suitable for image processing. The image analysis unit 131 is electrically connected with the image capturing module 110. When the image analysis unit 131 receives the environmental image, the image analysis unit 131 analyzes the environmental image to obtain a plurality of images of environmental objects in the environmental image and the method is specifically explained as follows.

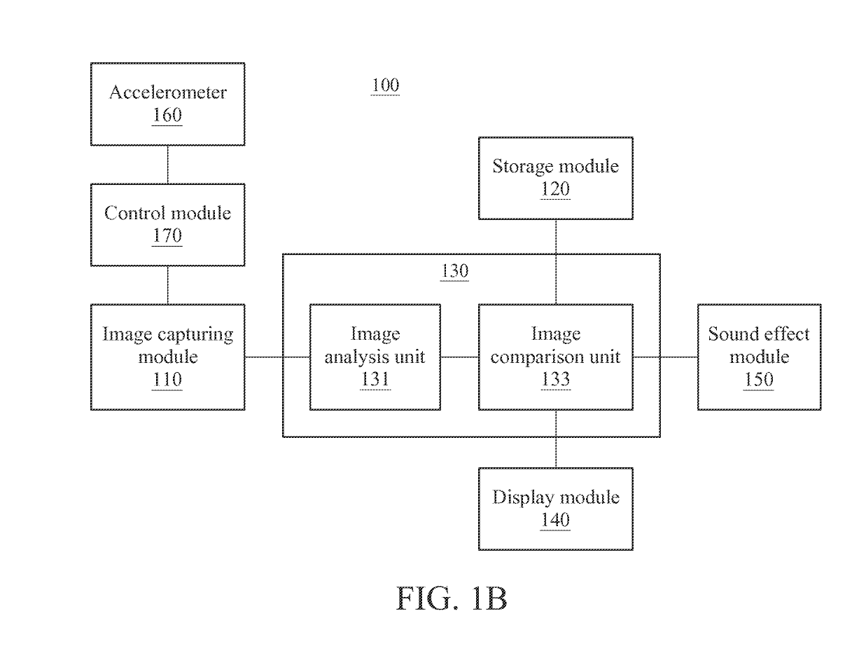

Please refer to FIG. 2. FIG. 2 is a diagram of the environmental image according to an embodiment of the present invention. In an embodiment, the image analysis unit 131 executes a high pass filter to the pixels of every column and every row in the environmental image 300 in FIG. 2 to define the nearby pixel color or the block with larger grayscale variation. The defined blocks are taken as the borders of each image of the environmental object in the image, so that the main images of environmental objects are obtained in the environmental image 300. Therefore, the image analysis unit 131 obtains a motorcycle image 310, a fence image 320, a car image 330, and a stair image 340 by analyzing the environmental image 300. Next, the image comparison unit 133 compares the plurality of images of environmental objects with the images of dangerous objects stored in the object database of the storage module 120 one by one to determine whether any of the plurality of images of environmental objects corresponds to the image of a dangerous object stored in the object database.

In practical implementation, taking the fence image 320 for example, when the 3D structural diagram or the planar diagram of the fence defined as the image of a dangerous object in the object database is compared with the fence image 320, the image comparison unit 133 firstly puts the left-side vertical bar in the 3D structural diagram of the fence in correspondence with the left-side vertical bar of the fence image 320, and the 3D structural diagram of the fence is zoomed in/out and rotated. If the right-side vertical bar and/or the crossbar in the fence image 320 overlap the right-side vertical bar and/or the crossbar in the 3D structural diagram of the fence, which the fence image 320 essentially corresponds to the 3D structural diagram of the fence is determined. In other words, at least one image of an environmental object essentially corresponds to an image of a dangerous object. In addition, the definition of the aforementioned overlapping in position can be the position difference of the two images less than a fault-tolerant threshold, such as 1/10 of the height of the whole fence.

The image comparison unit 133 sequentially compares the motorcycle image 310, the fence image 320, the person image 330, and the stair image 340 with the images of dangerous objects stored in the object database. When any image is determined that it essentially corresponds to the image of a dangerous object by the image comparison unit 133, the image comparison unit 133 determines that the environmental image 300 includes an image of a dangerous object and generates a warning message correspondingly. The essential correspondence between an image and a dangerous object is but not limited to the similarity. When no image corresponds to the image of any dangerous object after the comparisons of every image are done, the image comparison unit 133 determines that the environmental image 300 does not include the image of a dangerous object. The aforementioned warning message is but not limited to an image, a symbol or characters which are able to be displayed on the display module 140 of the portable device 100, or sirens from the sound effect module 150 of the portable device 100, or vibrations of the portable device 100.

In an embodiment, the images of dangerous objects in the object database are classified to the images of high-risk objects and the images of low-risk objects. For example, when the user using the portable device 100 is hit by a car or a motorcycle, he may be heavily injured, so cars and motorcycles are classified to high-risk objects. When the user is hit by a fence, a stair, or a pedestrian, he may fall at most, so the fence, the stair, and the pedestrian are classified to low-risk objects. When at least one of the images of environmental objects essentially corresponds to the image of a high-risk object, the image comparison unit 133 directly displays the environmental image 300 on the display module 140 of the portable device 100 as a warning message. Therefore, the user immediately knows that a high-risk object occurs ahead, such as a car. The classification of the high-risk objects and the low-risk objects is only for illustrating and practically the classification of the objects in the object database is designed based on the user's need according to the spirit of the present invention.

In another embodiment, please refer back to FIG. 2. Because the normal path of the user usually corresponds to the central block 301 of the environmental image 300 instead of the marginal blocks 303 and 305 on the two sides, the image analysis unit 131 only needs to analyze the central block 301 to obtain the images of environmental objects. In addition, because of the depth of field and the spatial characteristics of the obtained environmental image 300, the central block 301 is specified to the trapezoid shown in FIG. 2.

In another embodiment of the present invention, because the portable device 100 is not always used by the user, the aforementioned method for sending the warning message is not running all the time. Please refer back to FIG. 1B, the portable device 100 further has an accelerometer 160 and a control module 170. The control module 170 is electrically connected with the accelerometer 160 and the image capturing module 110.

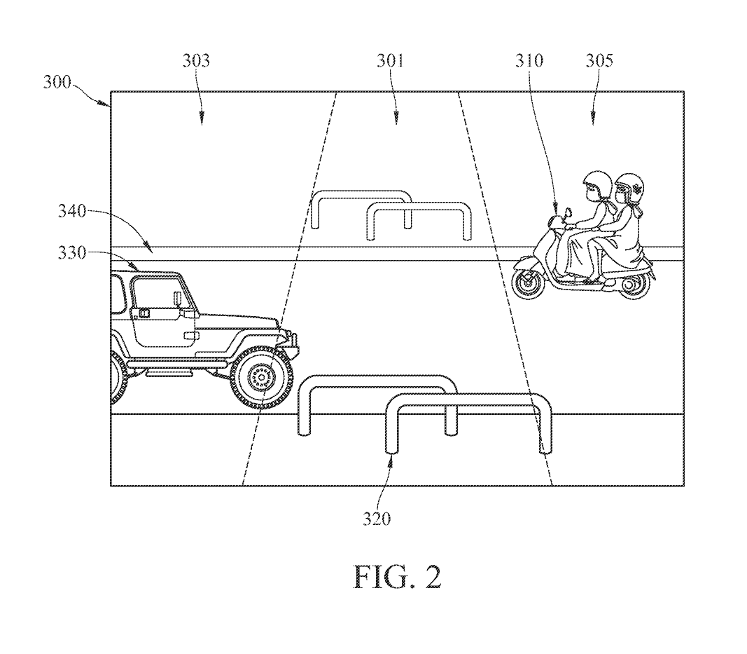

The accelerometer 160 is for detecting the acceleration value of the portable device 100. The control module 170 is for determining according to the acceleration value whether the portable device 100 moves, and when the portable device 100 moves, the control module 170 generates a control signal to make the image capturing module 110 capture the environmental image toward the first direction 200. For example, please refer to FIG. 3A to FIG. 3C. FIG. 3A to 3C are diagrams of the accelerations of the portable device according to an embodiment of the present invention. First, a first axis D1 parallel to the direction of the display module 140 of the portable device 100 is defined, and a second axis D2 orthogonal to the direction of the display module 140 is defined. The accelerometer 160 is at least a two-axis accelerometer to detect the acceleration on the first axis D1 and the acceleration on the second axis D2.

As shown in FIG. 3A, when the portable device 100 is upright, that is, the second axis D2 is parallel to the horizontal plane, normally the user does hold the portable device 100 in this way and walk at the same time, and meanwhile, the gravitational acceleration of the portable device 100 is parallel to the first axis D1, that is, there is no component of the gravitational acceleration on the second axis D2. As shown in FIG. 3B, when the portable device 100 is placed in flat position, that is, the first axis D1 is parallel to the horizontal plane, normally the user also does not hold the portable device 100 in this way and walk at the same time, and meanwhile, the gravitational acceleration of the portable device 100 is parallel to the second axis D2, that is, there is no component of the gravitational acceleration on the first axis D1. As shown in FIG. 3C, the portable device 100 tilts and neither of the first axis D1 and the second axis D2 is not parallel to the horizontal plane. Normally it is the scenario when the user uses the portable device 100 and walks at the same time. The gravitational acceleration of the portable device 100 does is not parallel to any axis, so the two axes both have the component of the gravitational acceleration.

In other words, when the control module 170 determines that one of the two acceleration values detected by the accelerometer 160 is almost zero, that the user does not use the portable device 100 and walks at the same time is determined, so generating the control signal is not needed to make the image capturing module 110 capture the environmental image toward the first direction. On the contrary, when both the acceleration values are not zero, even the two acceleration values changes periodically, the control module 170 determines that the user uses the portable device 100 and walks at the same time, so generating the control signal is needed to make the image capturing module 110 capture the environmental image toward the first direction. Therefore, when the user is phubbing, the portable device 100 applies the aforementioned method to notify the user when dangerous object occurs ahead.

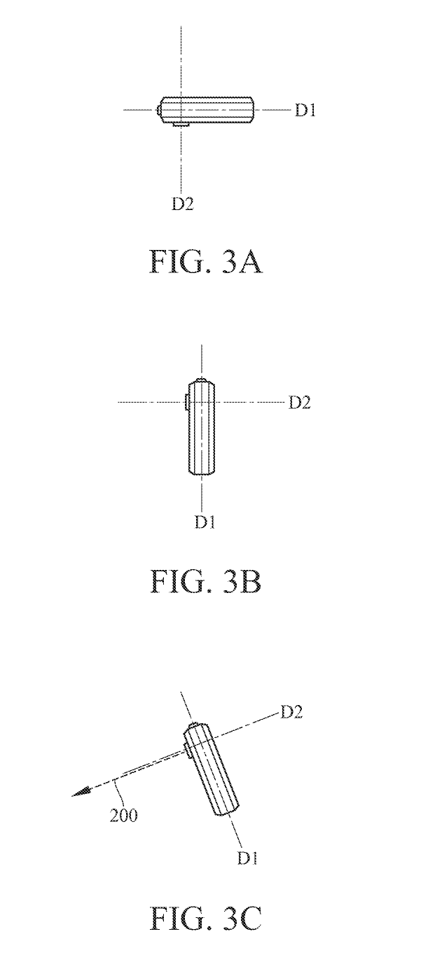

According to another embodiment of the present invention, please refer to FIG. 3C and FIG. 4 together. FIG. 4 is a usage diagram of the portable device according to an embodiment of the present invention. In the present embodiment, the image capturing module 110 is disposed on the portable device 100 and is rotatable, and the rotation axis is orthogonal to the first axis D1 and the second axis D2. First, generally the image capturing module 110 captures the environmental image toward the first direction 200, and as shown in FIG. 3C, the first direction 200 is parallel to the second axis D2. However, the scenario is capturing images from the ground and the user is not able to be informed for the dangerous object in the walking path. Therefore, the control module 170 further calculates the tilt status of the portable device 100 according to the two acceleration values, so that the image capturing module 110 is controlled to be rotated around the rotation axis until the first direction 200 is almost parallel to the horizontal plane, as shown in FIG. 4. Consequently, the environmental images are ensured to be captured toward the walking direction of the user.

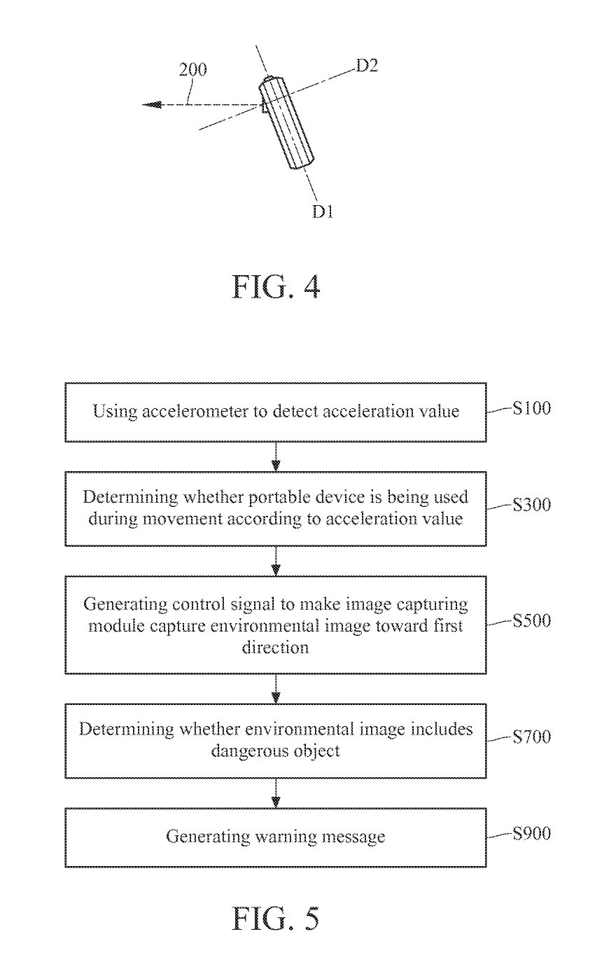

The hazard warning method applied by the portable device illustrated in an embodiment of the present invention is summarized in FIG. 5. FIG. 5 is a flowchart of the hazard warning method applied by the portable device according to an embodiment of the present invention. The method includes the following steps: as shown in the step S100, an accelerometer is used to detect at least one acceleration value. As shown in the step S300, whether the portable device moves is determined according to the at least one acceleration value. When that the portable device is not in use by the user during the movement is determined, the step S300 is repeated. On the contrary, when that the portable device is in use by the user during the movement is determined, as shown in the step S500, the control signal is generated to make the image capturing module to capture the environmental image toward the first direction. As shown in the step S700, whether the environmental image includes the image of a dangerous object is determined. When that the environmental image includes the image of a dangerous object is determined, a warning message is generated as shown in the step S900.

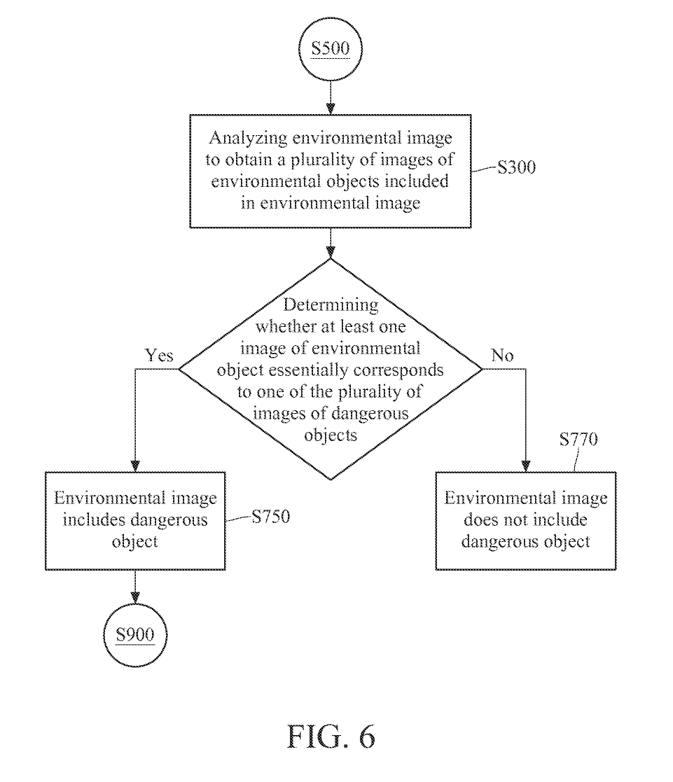

Referring to the details of the step S700, please refer to FIG. 6. FIG. 6 is a flowchart of the step S700 according to an embodiment of the present invention. The step S700 includes the following steps: as shown in the step S710, the environmental image is analyzed to obtain a plurality of images of environmental objects included in the environmental image. As shown in the step S730, for each of the images of environmental objects, whether the image of an environmental object essentially corresponds to one of the plurality of images of dangerous objects is determined. When at least one of the plurality of images of environmental objects essentially corresponds to at least one of the plurality of images of dangerous objects, as shown in the step S750, that the environmental image includes the dangerous object is determined. When all of the plurality of images of environmental objects do not essentially correspond to the plurality of images of dangerous objects, as shown in the step S770, that the environmental image does not include the dangerous object is determined.

According to the hazard warning method and a portable device utilizing the same illustrated in an embodiment of the present invention, when that the portable device in non-sleep mode is currently used by the user is determined, the environmental image ahead of the portable device/user is automatically captured and whether certain blocks in the environmental image include the image of a dangerous object is determined for selectively sending the warning message to notify the user. Therefore, phubbers can avoid accidents because the portable device keeps an eye on the road conditions automatically.

What is claimed is:

1. A hazard warning method adapted for a portable device having an image capturing module, comprising:
using the image capturing module to capture a environmental image toward a first direction when receiving a control signal;
determining whether the environmental image includes a dangerous object defined in an object database; and
generating a warning message when the environmental image includes the dangerous object.

2. The method of claim 1, wherein the object database stores a plurality of images of dangerous objects and the step of determining whether the environmental image includes a dangerous object comprises:
analyzing the environmental image to obtain a plurality of images of environmental objects included in the environmental image;
determining whether the image of an environmental object essentially corresponds to one of the plurality of images of dangerous objects;
when at least one of the plurality of images of environmental objects essentially corresponds to at least one of the plurality of images of dangerous objects, determining that the environmental image includes the dangerous object; and
when all of the plurality of images of environmental objects do not essentially correspond to the plurality of images of dangerous objects, determining that the environmental image does not include the dangerous object.

3. The method of claim 2, wherein the plurality of images of dangerous objects are classified to at least one image of a high-risk object and at least one image of a low-risk object, and when at least one of the plurality of images of environmental objects essentially corresponds to the at least one image of a high-risk object, the environmental image is taken as the warning message.

4. The method of claim 1, further comprising:
using an accelerometer to detect at least one acceleration value;
determining whether the portable device is moved according to the at least one acceleration value; and
generating the control signal when the portable device is moved.

5. The method of claim 4, further comprising adjusting the first direction according to the at least one acceleration value.

6. A portable device, comprising:
an image capturing module for capturing an environmental image toward a first direction when receiving a control signal;
a storage module for storing an object database; and
a determining module electrically connected with the image capturing module and the storage module, for determining whether the environmental image includes a dangerous object, wherein the dangerous object is defined in the object database, and a warning message is generated when the environmental image is determined that the dangerous object is included.

7. The portable device of claim 6, wherein the object database stores a plurality of images of dangerous objects and the determining module comprises:
an image analysis unit electrically connected with the image capturing module, for analyzing the environmental image to obtain a plurality of images of environmental objects included in the environmental image; and
an image comparison unit electrically connected with the image analysis unit and the storage module, for determining whether the images of environmental objects essentially corresponds to one of the plurality of images of dangerous objects for each of the images of environmental objects, wherein the environmental image is determined that the dangerous object is included when at least one of the plurality of images of environmental objects essentially corresponds to at least one of the plurality of images of dangerous objects, and the environmental image is determined that the dangerous object is not included when all of the plurality of images of environmental objects do not essentially correspond to the plurality of images of dangerous objects.

8. The portable device of claim 6, further comprising a display module, wherein the plurality of images of dangerous objects are classified to at least one image of a high-risk object and at least one image of a low-risk object, and when at least one of the plurality of images of environmental objects essentially corresponds to the at least one image of a high-risk object, the environmental image is taken as the warning message and displayed in the display module.

9. The portable device of claim 6, further comprising:
an accelerometer for detecting at least one acceleration value; and
a control module electrically connected with the accelerometer and the image capturing module for determining whether the portable device moves according to the at least one acceleration value, and the control signal is generated when the portable device moves.

10. The portable device of claim 9, wherein the image capturing module is rotatably disposed on the portable device, and the control module further rotates the image capturing module for adjusting the first direction according to the at least one acceleration value.
